(19) United States
(12) Patent Application Publication
(10) Pub. No.: US 2007/0116448 A1
(43) Pub. Date: May 24, 2007

(54) Focusing Method for an Image Device

(76) Inventors: Wei-Sheng Liao, Taipei County (TW); Chiou-Shann Fuh, Taipei County (TW); Ku-Nien Chang, Hsin-Chu (TW); Jen-Chun Chuang, Hsin-Chu (TW)

Correspondence Address: NORTH AMERICA INTELLECTUAL PROPERTY CORPORATION, P.O. BOX 506, MERRIFIELD, VA, 22116, US

(21) Appl. No.: 11/277,518

(22) Filed: Mar. 27, 2006

(30) Foreign Application Priority Data
Nov. 22, 2005 (TW) 094140992

(51) Int. Cl. G03B 13/18

(52) U.S. Cl. 396/89

(57) ABSTRACT

A focusing method is disclosed for moving a lens to a focal position when shooting a target object. According to the focusing method, the target object is photographed respectively with the lens at a plurality of initial testing positions to determine an initial sampling position and a sampling direction. And a plurality of candidate positions is determined according to the initial sampling position and the sampling direction. The target object is then photographed respectively at the candidate positions to generate a plurality of candidate images. For each of the candidate images, at least one focus value corresponding to the candidate image is calculated, and the focal position is determined according to the focus values corresponding to the candidate images.

### BACKGROUND OF THE INVENTION

1. Field of the Invention

The present invention relates to a focusing method for an image device, more particularly, to a method for moving a lens to a focal position when shooting a target object.

2. Description of the Prior Art

When an image device, such as a digital camera or a digital video recorder, is utilized for shooting a target object, the image device can initiate a focusing procedure to have a clearer image of the target object. In the conventional focusing procedure, the lens of the image device is moved back and forth so that the image device can take pictures of the target object at different lens positions. Each of the obtained images is then processed by the image device for calculating a corresponding focus value. Finally, a focal position for the lens is determined according to the plurality of focus values, and a clearer image can be obtained while shooting the target object with the lens at the determined focal position.

When determining the focal position and calculating the focus value for each image, one conventional method utilizes a gradient operator to generate the focus value by using every available pixels in an image. However, the above-mentioned method requires a significant amount of calculation to complete the focusing procedure. As the quantity of the pixels within an image increases, so does the burden of calculation and the time consumption.

In another conventional method for calculating a focus value of an image, the image is divided into a plurality of sub-blocks. The user of the image device may select one or more predetermined focusing blocks and have their focus values calculated. For example, as shown in FIG. 1, the image device can divide the image into a three-by-three array of sub-blocks and the central sub-block is set as the focusing block. FIG. 1 illustrates a diagram of an image being divided into a three-by-three array of sub-blocks and the shadowed sub-block being used as the focusing block. Since the user usually places the target object around the center of a picture, it is logical that the central sub-block is chosen as the focusing block. Nevertheless, there is still a possibility that the target object may be outside or over the selected focusing blocks. Thus the image shot according to the determined focal position may not be as clear as the user expected.

### SUMMARY OF THE INVENTION

An objective of the claimed invention is to provide a focusing method for moving a lens to a focal position when shooting a target object. The focusing method comprises: photographing the target object respectively at a plurality of initial testing positions to determine an initial sampling position and a sampling direction; determining a plurality of candidate position according to the initial sampling position and the sampling direction; photographing the target object respectively with the lens at the plurality of the candidate positions to generate a plurality of candidate images; calculating at least a focus value corresponding to each candidate image; and determining the focal position according to the plurality of focus values corresponding to the candidate images.

The claimed invention also provides a focusing method for moving a lens to a focal position when shooting a target object. The focusing method comprises: photographing the target object respectively with the lens at a plurality of candidate position to obtain a plurality of candidate images; dividing each candidate image into a plurality of sub-blocks; calculating a plurality of focus values of sub-blocks corresponding to specific sub-block positions; and determining the focal position according to the focus values corresponding to the candidate images.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates a diagram of an image being divided into a three-by-three array of sub-blocks and the shadowed sub-block being used as the focusing block.

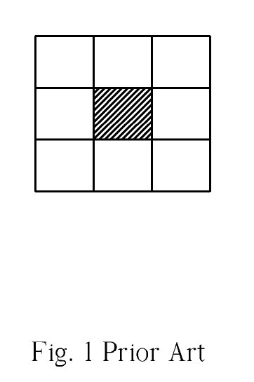

FIG. 2 illustrates a flowchart of moving a lens to a focal position when shooting a target object according to the present invention.

FIG. 3 illustrates a flowchart of moving a lens to a focal position when shooting a target object according to the present invention.

FIG. 4 illustrates a flowchart of moving a lens to a focal position when shooting a target object according to the present invention.

FIG. 5 illustrates of a diagram of setting a plurality of candidate positions along a first direction according to the present invention.

FIG. 6 illustrates a diagram of setting a plurality of candidate positions along a second direction according to the present invention.

FIG. 7 illustrates a diagram of an image being divided into a six-by-six array of sub-blocks according to the present invention.

FIG. 8 illustrates a diagram of a plurality of candidate images ft(x) and selected sub-blocks sb(x,y) according to the present invention.

### DETAILED DESCRIPTION

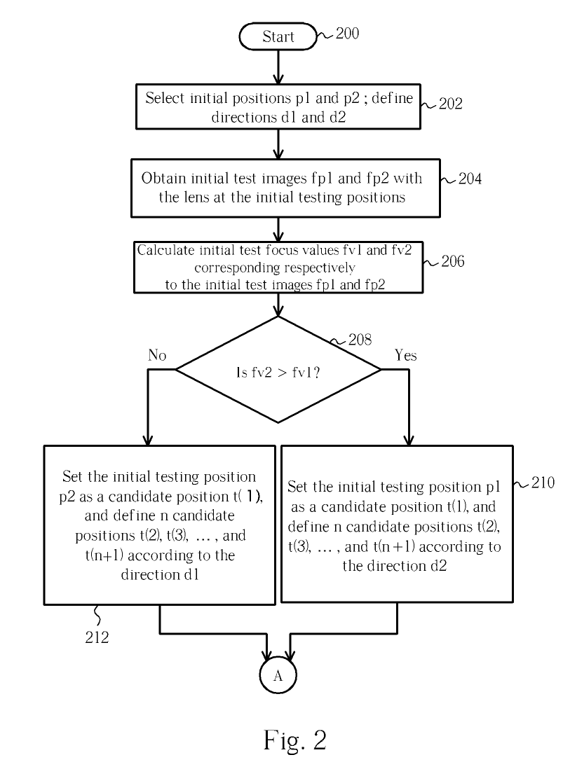

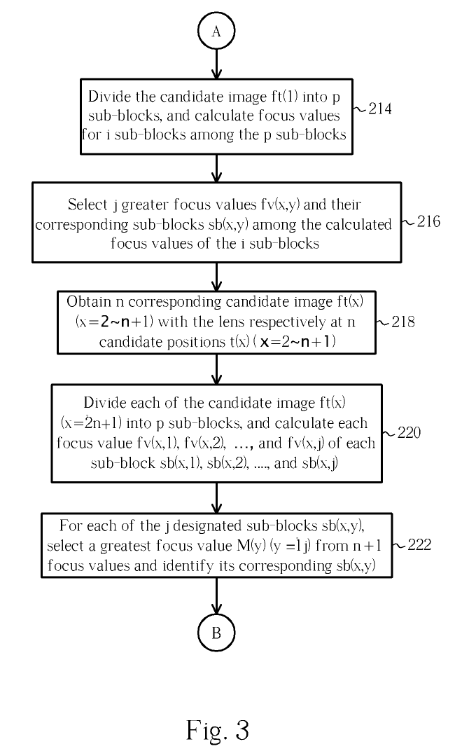

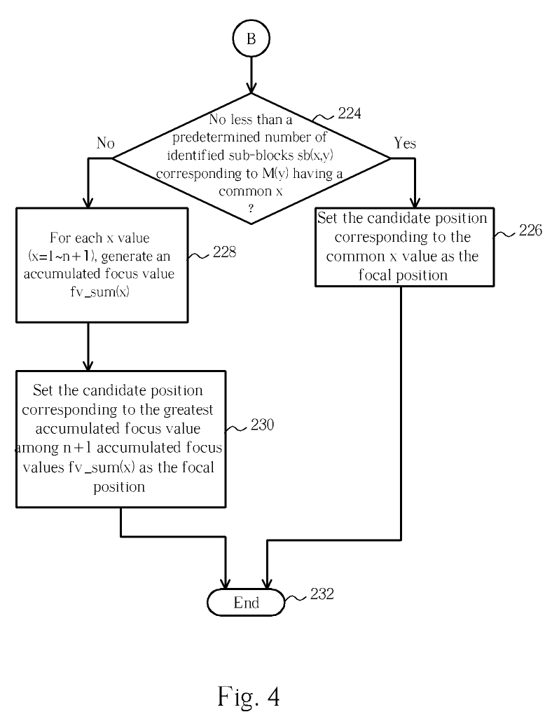

Please refer to FIG. 2, FIG. 3, and FIG. 4. FIG. 2, FIG. 3, and FIG. 4 illustrate flowcharts of moving a lens to a focal position when shooting a target object according to the present invention. Please note that the label “A” in FIG. 2 and FIG. 3 represents step 214 being executed after step 210 or 212. Similarly, the label “B” in FIG. 3 and FIG. 4 represents step 224 being executed after step 222. The focusing method includes the following steps:

Step 200: process starts;

Step 202: select two initial testing positions p1 and p2 for the lens; define a direction d1 as the direction from the initial testing position p1 to the initial testing position p2 and a direction d2 opposite to the direction d1;

Step 204: obtain an initial test image fp1 by photographing the target object with the lens at the initial testing position p1, and obtain an initial test image fp2 by photographing the target object with the lens at the initial testing position p2;

Step 206: calculate initial test focus value fv1 and initial test focus value fv2 corresponding to the initial test images fp1 and fp2, respectively;

Step 208: compare initial focus values fv1 and fv2; if the initial focus value fv2 is greater than the initial focus value fv1, then the process proceeds to step 210; otherwise, the process proceeds to step 212;

Step 210: set the initial testing position p2 as a candidate position t(1), and define n candidate positions t(2), t(3), . . . , and t(n+1) according to the direction d1; then the process proceeds to step 214;

Step 212: set the initial testing position p1 as a candidate position t(1), and define n candidate positions t(2), t(3), . . . , and t(n+1) according to the direction d2; then the process proceeds to step 214;

Step 214: divide the candidate image ft(1) corresponding to the candidate position t(1) into p sub-blocks, and calculate focus values for i sub-blocks among the p sub-blocks;

Step 216: select j greater focus values fv(x,y) and their corresponding sub-blocks b(x,y) among the calculated focus values of the i sub-blocks, wherein x=1, y=1˜j, and j≦i≦p;

Step 218: shoot the target object with the lens respectively at n candidate positions t(x) (x=2˜n+1) to obtain n corresponding candidate image ft(x) (x=2˜n+1);

Step 220: for each candidate image ft(x) (x=2˜n+1), divide the candidate image ft(x) into p sub-blocks with the same scheme utilized in Step 214, and calculate each focus value fv(x,1), fv(x,2), . . . , and fv(x,j) of each sub-block sb(x,1), sb(x,2), . . . , and sb(x,j), wherein the sub-block sb(x,1), sb(x,2), . . . , and sb(x,j) are respectively at substantially the same positions as sub-block sb(1,1), sb(2,2), . . . , and sb(1,j) in the candidate image ft(1);

Step 222: for each of the j designated positions of sub-blocks sb(x,y), select a greatest focus value M(y) (y=1˜j) from n+1 focus values fv(1,y), fv(2,y), . . . , and fv(n+1, y); identify each of the sub-block sb(x,y) corresponding to M(y);

Step 224: when no less than a predetermined number of identified sub-blocks sb(x,y) corresponding to M(y) mentioned in Step 222 having a common x value, the process proceeds to step 226; otherwise, the process proceeds to step 228;

Step 226: set the candidate position corresponding to the common x value mentioned in Step 224 as the focal position; process proceeds to step 232;

Step 228: for each x value (x=1˜n+1), sum up the focus values fv(x,1 ), fv(x,2), . . . , and fv(x,j) to generate an accumulated focus value fv_sum(x);

Step 230: select the greatest accumulated focus value fv_sum_M from n+1 accumulated focus values fv_sum(x), and set the candidate position corresponding to the greatest accumulated focus value fv_sum_M as the focal position; and

Step 232: end of the process.

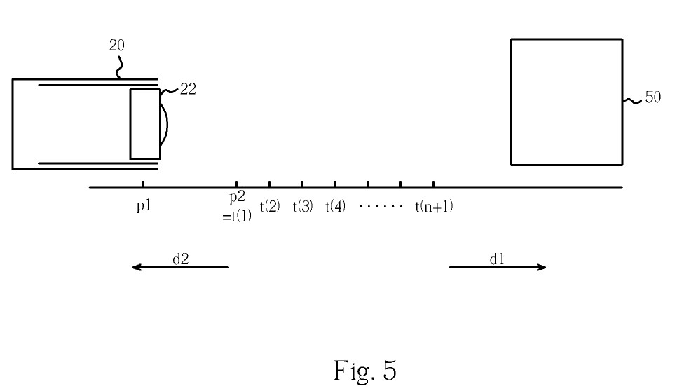

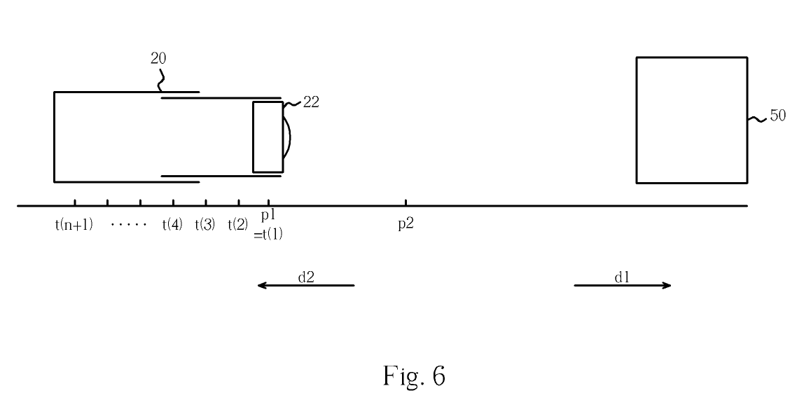

The operation of the focusing procedure will be further explained with a preferred embodiment in the following paragraphs. Please refer to FIG. 2, FIG. 3, FIG. 4, FIG. 5, and FIG. 6. FIG. 5 illustrates a diagram of setting a plurality of candidate positions along a first direction according to the present invention. FIG. 6 illustrates a diagram of setting a plurality of candidate positions along a second direction according to the present invention. In the preferred embodiments, the image device 20 can be a digital video recorder or a digital video camera with a lens 22 therein. Firstly, two initial testing positions p1 and p2 are separated by a first predetermined distance and selected such that initial testing positions p1 and p2 lie between the lens 22 and a target object 50. Furthermore, as shown in FIG. 5 and FIG. 6, a direction d1 is defined as the direction from the initial testing position p1 to the initial testing position p2, and a direction d2 is defined as the opposite direction of the direction d1 (steps 200 and 202). The image device 20 photographs the target object 50 when the lens 22 is at the initial testing position p1 and the initial testing position p2 to obtain two corresponding initial test images fp1 and fp2 (step 204). Afterwards, the image device 20 calculates an initial test focus value fv1 corresponding to the initial test image fp1 and an initial test focus value fv2 corresponding to the initial test image fp2 (step 206), and details about the calculation of the initial test focus values fv1 and fv2 will be mentioned later. The image device 20 compares the initial test focus values fv1 and fv2 (step 208). If fv2 is greater than fv1, the image device 20 sets the initial testing position p2 as a candidate position t(1) and define n more candidate positions t(2), t(3), . . . , and t(n+1) along the direction d1 with equal intervals defined by a second predetermined distance as shown in FIG. 5 (step 210). On the other hand, if the initial test focus value fv2 is not greater than the initial test focus value fv1, the image device 20 sets the initial testing position p1 as a candidate position t(1) and define n more candidate positions t(2), t(3), . . . , and t(n+1) along the direction d2 with equal intervals defined by a third predetermined distance as shown in FIG. 6 (step 212). Though in the preferred embodiment, the second predetermined distance is set to be equal to the predetermined third distance, however, the present invention is not so limited such that the second and third predetermined distances can be different. Furthermore, for the n candidates position t(2), t(3), . . . , and t(n+1) in the preferred embodiment, all intervals in between are equal. But in other embodiments according to the present invention, the plurality of intervals can be different.

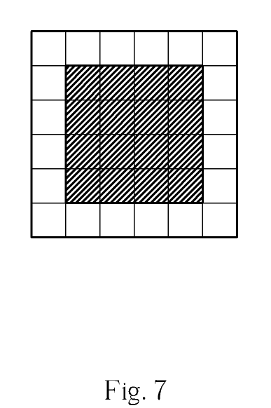

In step 206, the initial test images fp1 and fp2 are divided respectively into a plurality of sub-blocks, and a portion of the sub-block is utilized for the calculation of initial focus values fv1 and fv2. Please refer to FIG. 7. FIG. 7 illustrates a diagram of an image being divided into a six-by-six array of sub-blocks. As shown in FIG. 7, the initial test image fp1 is being divided into 36 equally sized sub-blocks, and the 16 shadowed sub-blocks are being taken into consideration to calculate the initial focus value fv1. In the preferred embodiment, focus values of each and every 16 shadowed sub-blocks are calculated and accumulated to obtain the initial test focus value fv1 . Similarly, the initial test image fp2 is being divided into 36 equally sized sub-blocks, and the 16 shadowed sub-blocks are utilized to obtain the initial test focus value fv2. In the preferred embodiment, the sub-blocks outside the shadowed portion in the initial test images fp1 and fp2 are not utilized (as shown in FIG. 7, there are 20 non-shadowed sub-blocks) when calculating the initial test focus values fv1 and fv2 to reduce the complexity of calculation as the sub-blocks at outer rim of an image are considered as assisting information only in the focusing calculation. Of course, in other embodiments, all the sub-blocks of an image can be considered for calculating the focus value. As the detailed calculation of the focus value is well known to those having average skilled in the art, therefore it will not be reiterated.

Please note that the present invention is not limited to dividing an image into a six-by-six array of sub-blocks, the image can also be divided into sub-blocked having different quantities, shapes, or unevenly sizes. The present invention is also not limited to take only the central portion of the image into consideration when calculating the focus value. The present invention can be easily utilized with other combination of positions or quantities of sub-blocks in an image for calculating the focus value.

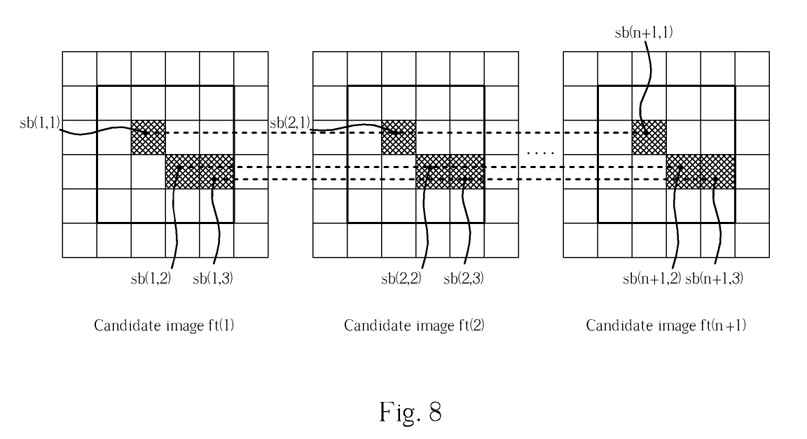

Please refer to FIG. 8. FIG. 8 illustrates a diagram of a plurality of candidate images ft(x) and selected sub-blocks sb(x,y). In order to explain the operation of the focusing procedure, the initial test focus value fv2 is assumed to be greater than the initial focus value fv1, and therefore the candidate positions t(1)˜t(n+1) have been determined as shown in FIG. 5. The image device 20 divides the candidate image ft(1) into p sub-blocks, which is the initial test image fp2 corresponding to the candidate position t(1), and each focus value of i sub-blocks among the p sub-blocks are calculated (step 214). In this embodiment, as previously mentioned, at step 206 the candidate image ft(1) has been divided into 36 equally sized sub-blocks, and each focus value of the 16 shadowed sub-blocks has been calculated. Therefore, the calculation of step 214 has been executed completely together with step 206, and there is no need to repeat step 214 which can be an optional step. However, if the operation of step 214 has not been executed together with step 206, then step 214 becomes a necessary step. The image device 20 selects the greater j focus values fv(x,y) from i sub-blocks and their corresponding sub-blocks sb(x,y), wherein x=1, y=1˜j, j≦i≦p (step 216). For example, j=3, i=4*4=16, p=6*6=36, and as for the candidate image ft(1), the image device 20 selects the 3 greater focus values fv(1,1), fv(2,2), and fv(3,3) and their corresponding sub-blocks sb(1,1), sb(1,2), and sb(1,3).

Next, the image device 20 photographs the target object 50 with the lens at n candidate position t(x) (x=2˜n+1) to obtain n corresponding candidate image ft(x) (x=2˜n+1) (step 218). Each of the n corresponding candidate image ft(x) is divided into p sub-blocks according to the method when dividing the candidate image ft(l), and each of the focus value fv(x,1), fv(x,2), . . . , and fv(x,j) of the sub-block sb(x,1), sb(x,2), . . . , sb(x,j) is calculated, wherein the sub-block sb(x,1), sb(x,2), . . . , and sb(x,j) are at the positions identical to the sub-block sb(1,1), sb(1,2), . . . , and sb(x,j) in the candidate image ft(1) (step 220). And the sub-blocks sb(x,y) (x=1˜+1, y=1˜j) become the focusing area when the image device 20 is shooting the target object 50. As Shown in FIG. 8, it demonstrates only the candidate images ft(1), ft(2), ft(n+1) and the selected sub-blocks sb(1,1), sb(1,2), sb(1,3), sb(2,1), sb(2,2), sb(2,3), sb(n+1,1), sb(n+1,2), sb(n+1,3). The sub-blocks sb(1,1), sb(2,1), . . . , and sb(n+1,1) are all at substantially identical positions in each of the image, and so as for the sub-blocks sb(1,2), sb(2,2), . . . , sb(n+1,2), and for the sub-blocks (1,3), sb(2,3), . . . , sb(n+1,3). Furthermore, for all sub-blocks sb(1,1), sb(2,1), . . . , sb(n+1,1) that having y=1, the image device 20 selects a greatest focus value M1(1) from n+1 focus values fv(1,1), fv(2,1), . . . , fv(n+1,1); for all sub-blocks sb(1,2), sb(2,2), . . . , sb(n+1,2) that having y=2, the image device 20 also selects the greatest focus value M(2); for all sub-blocks sb(1,3), sb(2,3), . . . , sb(n+1,3) that having y=3, the image device 20 selects the greatest focus value M(3); and the process repeats for each and every y value. The sub-blocks corresponding to M(y) values are also identified. (step 222)

The image device 20 determines whether a predetermined number of sub-blocks sb(x,y) corresponding to M(y) having a common x value. In the preferred embodiment, the predetermined number is a smallest positive integer that is greater than j/2, which means that when j=3, the predetermined number is 2, and the image device 20 determines whether if there are at least two sub-blocks corresponding to focus values M(1), M(2), and M(3) having the same x value (step 224). If so, the candidate position corresponding to the x value is set as the focal position of the lens 22 (step 226, 230), and a clearer image can be obtained when shooting the target object 50 with the lens 22 at the focal position. In contrary, if the sub-blocks corresponding to the focus values M(1), M(2), and M(3) having different x values, the image device 20 sums up fv(x,1), fv(x,2), fv(x,3) to obtain an accumulated focus value fv_sum(x) for each candidate image ft(x) (x=1˜n+1) (step 228). After that, the image device 20 selects the greatest accumulated focus value fv_sum_M from n+1 accumulated focus value fv_sum, and sets the candidate position corresponding to the greatest accumulated focus value fv_sum_M as the focal position of the lens 22 (step 230, 232).

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A focusing method for moving a lens to a focal position when shooting a target object, the focusing method comprising:
photographing the target object respectively at a plurality of initial testing positions to determine an initial sampling position and a sampling direction;
determining a plurality of candidate positions according to the initial sampling position and the sampling direction;
photographing the target object respectively with the lens at the candidate positions to generate a plurality of candidate images;
calculating at least a focus value corresponding to each candidate image; and
determining the focal position according to the focus values corresponding to the candidate images.

2. The focusing method of claim 1 wherein a plurality of initial test images is generated by photographing the target object with the lens at the initial testing positions, and the step of determining the initial sampling position and the sampling direction further comprises:
calculating respectively a plurality of initial test focus values corresponding to the initial test images; and
determining the initial sampling position and the sampling direction according to the initial test focus values.

3. The focusing method of claim 2 wherein the step of calculating the initial test focus values further comprises:
for each initial test image:
dividing the initial test image into a plurality of sub-blocks;
selecting at least a portion of the sub-blocks;
calculating focus values corresponding to the selected sub-blocks; and
generating an initial test focus value by accumulating the focus values corresponding to the selected sub-blocks.

4. The focusing method of claim 2 wherein the initial testing positions comprises a first initial testing position and a second initial testing position corresponding respectively to a first initial test focus value and a second initial test focus value; the step of determining the sampling direction further comprising:
defining the sampling direction as the direction from the first initial testing position to the second initial testing position if the second initial test focus value is greater than the first initial test focus value; and
defining the sampling direction as the direction from the second initial testing position to the first initial testing position if the second initial test focus value is no greater than the first initial test focus value.

5. The focusing method of claim 2 wherein the step of determining the initial sampling position further comprises:
setting the second initial testing position as the initial sampling position if the second initial test focus value is greater than the first initial test focus value; and
setting the first initial testing position as the initial sampling position if the second initial test focus value is no greater than the first initial test focus value.

6. The focusing method of claim 1 wherein the initial sampling position is one of the candidate positions.

7. The focusing method of claim 1 wherein the step of calculating the at least a focus value corresponding to each candidate image further comprises:
dividing each candidate image into a plurality of sub-blocks; and
calculating a focus value of a sub-block for each candidate image, wherein the sub-block corresponds to a specific sub-block position.

8. The focusing method of claim 7 wherein the method further comprises:
calculating the focus values corresponding to at least one of the sub-blocks of an initial sampling image corresponding to the initial sampling position; and
selecting the at least a specific sub-block position according to the greater focus values among the plurality of focus values of the initial sampling image and their corresponding sub-blocks.

9. The focusing method of claim 7 wherein the step of determining the focal position further comprises:
for each of the specific sub-block position, comparing the focus values of the sub-blocks of the candidate images corresponding to the specific sub-block position for selecting a greatest focus value; and
determining the focal position from the candidate positions according to the greatest focus values.

10. The focusing method of claim 9 wherein the step determining of the focal position from the candidate positions according to the greatest focus values further comprises:
identifying candidate positions corresponding to the greatest focus values; and
if no less than a predetermined number of the identified candidate positions correspond to a common candidate position, utilizing the common candidate position as the focal position.

11. The focusing method of claim 10 wherein the number of the specific sub-block positions is j, and the predetermined number is a smallest integer that is greater than j/2.

12. The focusing method of claim 10 wherein the step of determining the focal position from the candidate positions according to the greatest focus values further comprises:
if less than the predetermined number of the identified candidate positions correspond to a common candidate position:
for each candidate image, accumulating the focus values of the sub-blocks of the specific sub-block positions for generating an accumulated focus value;
comparing the accumulated focus values corresponding to the candidate images for selecting a greatest accumulated focus value; and
utilizing the candidate position corresponding to the greatest accumulated focus value as the focal position.

13. The focusing method of claim 7 wherein the step of determining the focal position from the candidate positions according to the greatest focus values further comprises:
for each candidate image, accumulating the focus values of the sub-blocks of the specific sub-block positions for generating an accumulated focus value;
comparing the accumulated focus values corresponding to the candidate images for selecting a greatest accumulated focus value; and
utilizing the candidate position corresponding to the greatest accumulated focus value as the focal position.

14. A focusing method for moving a lens to a focal position when shooting a target object, the focusing method comprising:
photographing the target object respectively with the lens at a plurality of candidate positions to obtain a plurality of candidate images;
dividing each candidate image into a plurality of sub-blocks;
calculating a plurality of focus values of sub-blocks corresponding to specific sub-block positions; and
determining the focal position according to the focus values corresponding to the candidate images.

15. The focusing method of claim 14 wherein the step of calculating the focus values corresponding to each candidate image further comprises:
calculating the focus values corresponding to at least one of the sub-blocks of an initial sampling image; and
selecting the at least a specific sub-block position according to the greater focus values among the plurality of focus values of the initial sampling image and their corresponding sub-blocks.

16. The focusing method of claim 14 wherein the step of determining the focal position comprises:
for each of the specific sub-block position, comparing the focus values of the sub-blocks of the candidate images corresponding to the specific sub-block position for selecting a greatest focus value; and
determining the focal position from the candidate positions according to the greatest focus values.

17. The focusing method of claim 16 wherein the step of determining the focal position from the candidate positions according to the greatest focus values further comprises:
identifying candidate positions corresponding to the greatest focus values; and
if no less than a predetermined number of the identified candidate positions correspond to a common candidate position, utilizing the common candidate position as the focal position.

18. The focusing method of claim 17 wherein the number of the specific sub-block positions is j, and the predetermined number is a smallest integer that is greater than j/2.

19. The focusing method of claim 17 wherein the step of determining the focal position from the candidate positions according to the greatest focus values further comprises:
if less than the predetermined number of the identified candidate positions correspond to a common candidate position:
for each candidate image, accumulating the focus values of the sub-blocks of the specific sub-block positions for generating an accumulated focus value; and
comparing the accumulated focus values corresponding to the candidate images for selecting a greatest accumulated focus value; and
utilizing the candidate position corresponding to the greatest accumulated focus value as the focal position.

20. The focusing method of claim 14 wherein the step of determining the focal position from the candidate positions according to the greatest focus values further comprises:
for each candidate image, accumulating the focus values of the sub-blocks of the specific sub-block positions for generating an accumulated focus value;
comparing the accumulated focus values corresponding to the candidate images for selecting a greatest accumulated focus value; and
utilizing the candidate position corresponding to the greatest accumulated focus value as the focal position.
